(19) United States
(12) Patent Application Publication
(10) Pub. No.: US 2025/0245641 A1
(43) Pub. Date: Jul. 31, 2025

(54) GATE DEVICE

(71) Applicant: Toshiba Tec Kabushiki Kaisha, Tokyo (JP)

(72) Inventors: Kouki OKANO, Yokohama Kanagawa (JP); Tomonori SUGIYAMA, Yokohama Kanagawa (JP); Fumio NAKATSUKASA, Yokohama Kanagawa (JP); Yuna OTANI, Ota Tokyo (JP); Kanako NAKAHARA, Shinagawa Tokyo (JP)

(21) Appl. No.: 18/909,505

(22) Filed: Oct. 8, 2024

(30) Foreign Application Priority Data
Jan. 26, 2024 (JP) 2024-010071

(51) Int. Cl. G06Q 20/20

(52) U.S. Cl. CPC G06Q 20/20

(57) ABSTRACT

According to an embodiment, a gate device switches an operation mode between a first mode in which notification is made when a detector that detects a person passing through a passage detects a person passing through the passage and a second mode in which no notification is made even when the detector detects a person passing through the passage. Further, the gate device changes a light emission state of a light emitter for making notification to different states between the first mode and the second mode.

### CROSS-REFERENCE TO RELATED APPLICATIONS

This application is based upon and claims the benefit of priority from the prior Japanese Patent Application No. 2024-10071, filed on Jan. 26, 2024, the entire contents of which are incorporated herein by reference.

### FIELD

An embodiment to be described here generally relates to a gate device.

### BACKGROUND

In recent years, a store system in which customers operate mobile terminals by themselves to register products to be purchased on a sales floor where products are displayed and operate accounting machines by themselves to pay for the products to be purchased at a checkout counter separate from the sales floor has been developed. By introducing this type of store system in mass retailers such as supermarkets, it is possible to ease congestion at the checkout counter. In addition, the number of sales clerks (employees) in charge of accounting can be reduced, it is possible to reduce labor costs.

However, no sales clerk is involved in payment, and thus, there is a concern that a fraud that customers leave the store without making a payment is likely to occur. In this regard, installing a gate device that allows only customers who have completed payments to pass therethrough in a passage leading to the exit of the checkout counter is considered. However, in the case where the gate device is installed, a sales clerk for supporting a customer when, for example, he/she is unable to pass through the gate device is necessary. The sales clerk needs to stand by near the gate device to monitor the state of the gate device, which is inefficient.

### BRIEF DESCRIPTION OF THE DRAWINGS

FIG. 1 is a schematic diagram showing a schematic configuration of a store system according to this embodiment.

FIG. 2 is a schematic diagram showing main data described in a transaction file.

FIG. 3 is a block diagram showing a main circuit configuration of a gate device.

FIG. 4 is a perspective view showing an example of a gate mechanism.

FIG. 5 is a schematic diagram showing a main functional configuration of a processor of the gate device.

FIG. 6 is a flowchart showing a procedure of main information processing executed by the processor of the gate device.

FIG. 7 is a flowchart showing a procedure of main information processing executed by the processor of the gate device.

FIG. 8 is a flowchart showing a procedure of main information processing executed by the processor of the gate device.

FIG. 9 is a diagram showing an example of an impassible image and a state of a patrol lamp.

FIG. 10 is a diagram showing an example of a warning image and a state of the patrol lamp.

FIG. 11 is a diagram showing an example of a checking image and a state of the patrol lamp.

FIG. 12 is a diagram showing an example of a sales clerk call image and a state of the patrol lamp.

FIG. 13 is a diagram showing an example of a passage permission image and a state of the patrol lamp.

FIG. 14 a diagram showing an example of a passage error image and a state of the patrol lamp.

FIG. 15 is a diagram showing an example of an accounting image and a state of the patrol lamp.

FIG. 16 is a diagram describing the state transition of the patrol lamp in this embodiment.

FIG. 17 is a diagram describing the state transition of a patrol lamp in another embodiment.

### DETAILED DESCRIPTION

According to an embodiment, a gate device includes a gate mechanism; and a processor. The gate mechanism is disposed along a passage through which a customer passes and includes a light emitter and a detector. The light emitter is provided above the gate mechanism. The detector is configured to detect a person passing through the passage. The processor is configured to switch an operation mode of the gate mechanism between a first mode in which notification is made by the light emitter when the detector detects a person passing through the passage and a second mode in which no notification is made even when the detector detects a person passing through the passage. Further, the processor changes a light emission state of the light emitter to different states between the first mode and the second mode.

A gate device according to an embodiment, which allows a sales clerk to monitor the state of a device without placing the sales clerk near the device, will be described below with reference to the drawings. Note that in the drawings, the same reference symbols denote the same or similar portions. This embodiment illustrates a gate device of a store system in which a customer who is a transaction target operates a mobile terminal by himself/herself to register a product to be purchased and operates an accounting machine by himself/herself to pay for the product to be purchased. The store system will be described first.

### Schematic Description of Store System

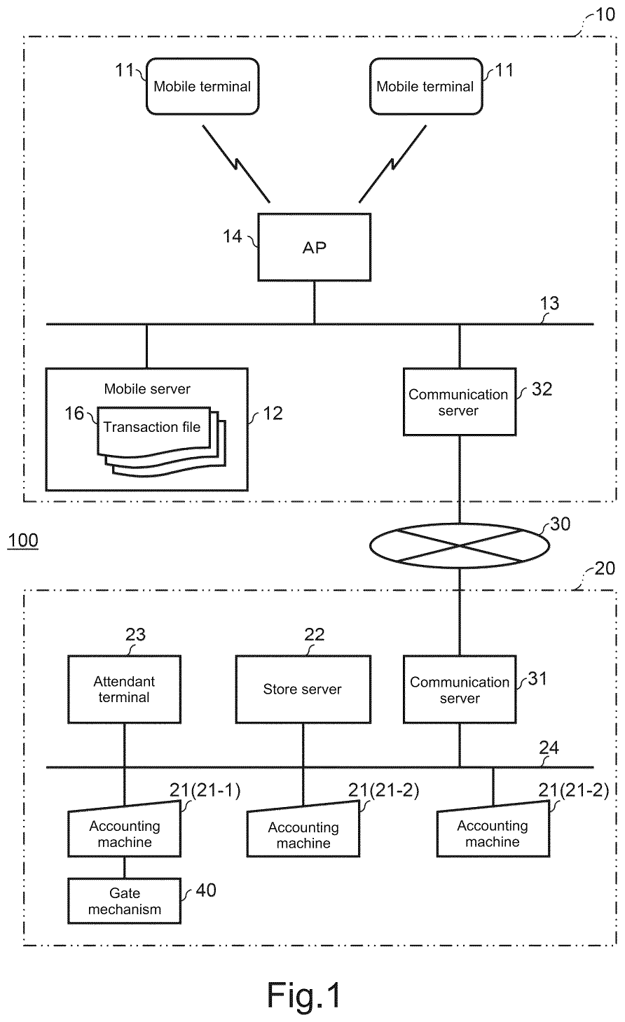

FIG. 1 is a schematic diagram showing a schematic configuration of a store system 100 according to an embodiment. The store system 100 includes a sales floor system 10 constructed on a sales floor where products are displayed and a checkout counter system 20 constructed at a checkout counter separate from the sales floor.

The sales floor system 10 includes a plurality of mobile terminals 11 and a mobile server 12. The sales floor system 10 wirelessly connects the plurality of mobile terminals 11 and the mobile server 12 via an access point 14 of a communication network 13.

The mobile terminal 11 is a portable information terminal that includes an input/output device such as a touch panel and a camera, and a wireless communication unit capable of performing wireless communication with the access point 14. For example, a smartphone owned by a customer, a handy terminal lent by a store, or a tablet terminal mounted on a shopping cart can be used as the mobile terminal 11. For example, a smartphone is used as the mobile terminal 11 by installing application software for assisting a customer in shopping at a store where the sales floor system 10 is introduced, a so-called shopping application.

The mobile terminal 11 is operated by a customer who collects products to be purchased while moving the sales floor. The customer operates the mobile terminal 11 to input data relating to a product to be purchased each time he/she picks up the product to be purchased. For example, the customer scans the barcode of the product to be purchased using a camera of the mobile terminal 11 to input the product code of the product to be purchased. For example, the customer operates the touch panel of the mobile terminal 11 to input the product code, the number of products, and the like of the product to be purchased. The data relating to the product to be purchased input to the mobile terminal 11 is wirelessly transmitted and received by the mobile server 12 via the access point 14.

The mobile server 12 is a computer for supporting a transaction with a customer who registers a product to be purchased using the mobile terminal 11. The mobile server 12 has a storage region for storing a plurality of transaction files 16. The transaction file 16 is a data file created for each transaction with a customer who uses the mobile terminal 11.

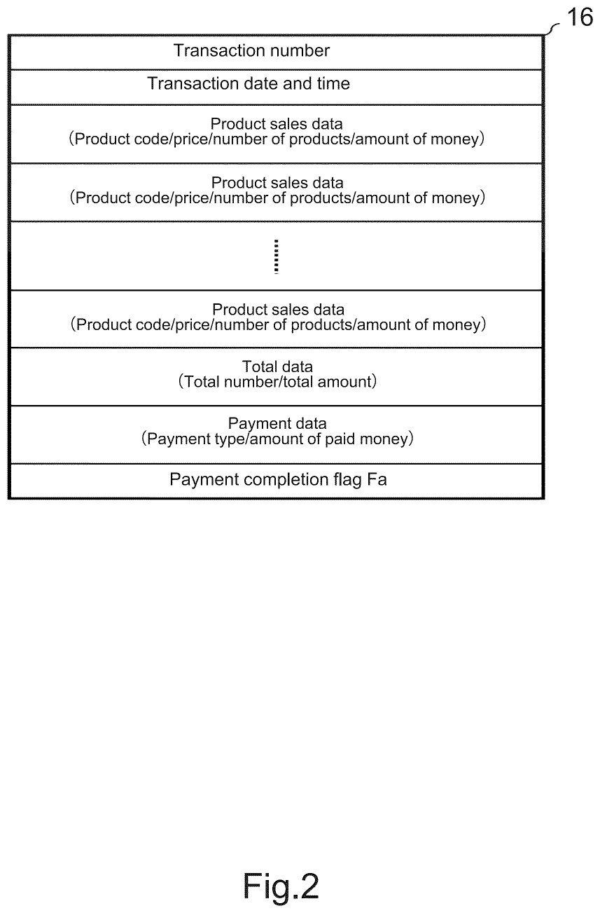

FIG. 2 is a schematic diagram showing main data described in the transaction file 16. As shown in FIG. 2, a transaction number, transaction date and time, one or more pieces of product sales data, total data, payment data, a payment completion flag Fa, and the like are described in the transaction file 16.

The transaction number is a unique number that is issued to individually identify the transaction using the mobile terminal 11. For example, the transaction number is a sequential number that is incremented by “1” each time a transaction using the mobile terminal 11 is started. The transaction number may be a sequential number that is incremented by “1” each time payment for the transaction using the mobile terminal 11 is instructed. The transaction number may be a unique number based on another algorithm.

The transaction date and time is the date and time the transaction was made. The time may be the time the transaction was started or the time the payment for the transaction was instructed.

The product sales data is created on the basis of data relating to a product to be purchased input to the mobile terminal 11. The product sales data includes a product code, a price, the number of products, the amount of money, and the like of the product to be purchased. The product code is an identification code of the product to be purchased input to the mobile terminal 11. The price is a price acquired from a price look up (PLU) file in which the price of each product is set in association with the product code of the product. The number of products is, in the case where the number of products is input to the mobile terminal 11, this number, and “1” in the case where the number of products is not input. The amount of money is the amount of money calculated by multiplying the price by the number of products.

The total data includes data regarding the total number and the total amount. The total number is the total number of products of the product sales data included in the transaction file 16. The total amount is the total amount of money of the product sales data included in the transaction file 16.

The payment data includes a payment type for identifying the payment method and the amount of money paid by the payment method. When the payment for the transaction identified by the transaction number is performed using an accounting machine 21 described below, the payment data is described in the transaction file 16.

The payment completion flag Fa is a 1-bit data for determining whether or not the payment for the transaction managed in the transaction file 16 has been completed. In this embodiment, the payment completion flag Fa indicating that the payment has not been completed is set to “0”, and the payment completion flag Fa indicating that the payment has been completed is set to “1”.

FIG. 1 will be described again. When a customer has finished shopping, he/she operates the mobile terminal 11 to instruct accounting. By performing the operation to instruct accounting, a computer-readable code for accounting is displayed on the display device of the mobile terminal 11. The computer-readable code is, for example, a barcode or a two-dimensional code. In his embodiment, the computer-readable code is a barcode. Hereinafter, the computer-readable code (barcode) for accounting will be referred to as an accounting barcode. The accounting barcode includes information for identifying the transaction file 16. The information is, for example, the transaction number. A customer can make a payment using the accounting machine 21 by causing the scanner of the accounting machine 21 to read the accounting barcode. The payment using the accounting machine 21 may be cashless payment such as electronic money payment, credit card payment, and code payment, payment in cash, or payment in cash vouchers such as gift certificates.

Note that in the case where application software for cashless payment, a so-called payment application, is installed in the mobile terminal 11, a payment can be made using the mobile terminal 11. The payment is cashless payment such as electronic money payment, credit card payment, and code payment. When a customer performs an operation for cashless payment on the mobile terminal 11, the payment data is wirelessly transmitted from the mobile terminal 11. The payment data includes the payment type indicating the payment method and the amount of paid money. For example, in the case where a consumer performs cashless payment using electronic money, the payment data including information regarding the payment type indicating electronic money and the amount of money paid by electronic money is wirelessly transmitted. The wirelessly transmitted payment data is received by the mobile server 12 via the access point 14.

The checkout counter system 20 includes a plurality of accounting machines 21, a store server 22, and an attendant terminal 23. The checkout counter system 20 connects the plurality of accounting machines 21, the store server 22, and the attendant terminal 23 via a communication network 24. The communication network 24 is, for example, a LAN. Note that although only one attendant terminal 23 is shown in FIG. 1, two or more attendant terminals 23 may be connected to the communication network 24, thereby forming the checkout counter system 20.

In the checkout counter system 20, a communication server 31 is connected to the communication network 24. In the sales floor system 10, a communication server 32 is connected to the communication network 13. The store system 100 connects the communication server 31 and the communication server 32 with an inter-server network 30. Such connection allows each accounting machine 21 and the store server 22 in the checkout counter system 20 and each mobile terminal 11 and the mobile server 12 in the sales floor system 10 to transmit/receive data to/from each other.

The accounting machine 21 includes a first accounting machine 21-1 equipped with a gate mechanism 40 and a second accounting machine 21-2 that is not equipped with the gate mechanism 40. The first accounting machine 21-1 equipped with the gate mechanism 40 is an example of a gate device. The gate device, i.e., the first accounting machine 21-1 equipped with the gate mechanism 40, will be described below in detail.

The second accounting machine 21-2 is a device for making a payment for a transaction with a customer who has operated the mobile terminal 11 to register a product to be purchased with self-service. As the second accounting machine 21-2, a known accounting machine that is also called a point of sales (POS) terminal, a payment terminal, or the like can be applied as it is. The second accounting machine 21-2 is a self-service type where a customer performs an operation for making a payment for the transaction by himself/herself. The second accounting machine 21-2 may be a face-to-face type where a sales clerk performs an operation for making a payment for the transaction.

The second accounting machine 21-2 includes a scanner for reading the accounting barcode. By reading the accounting barcode using the scanner, the second accounting machine 21-2 acquires the transaction file 16 identified by the information of the accounting barcode from the mobile server 12. The second accounting machine 21-2 then makes a payment for the transaction on the basis of the data of the transaction file 16. The payment may be cashless payment such as electronic money payment, credit card payment, and code payment, payment in cash, or payment in cash vouchers such as gift certificates, as described above.

The second accounting machine 21-2 issues a receipt that records the details of the transaction such as the transaction number, the transaction date and time, the product sales data, the total data, and the payment data each time a payment for the transaction is made. The second accounting machine 21-2 then prints the accounting barcode read by the scanner on the receipt.

The receipt may be displayed in the form of an electronic receipt on the mobile terminal 11 held by the customer. The electronic receipt includes information that records the details of the transaction such as the transaction number, the transaction date and time, the product sales data, the total data, and the payment data, similarly to a receipt using paper as a medium. The accounting barcode is also displayed on this electronic receipt. Note that the information that records the details of the transaction does not necessarily need to be displayed and only the accounting barcode may be displayed on the mobile terminal 11.

The store server 22 is a computer that provides services for managing information regarding the sales, inventory, and the like of the store at the time point of the product sale by collecting and aggregating data of the transaction for which a payment has been made using each accounting machine 21 via the communication network 24.

The attendant terminal 23 is installed at an attendant counter provided in part of the checkout counter for a sales clerk referred to as an attendant to be resident. The attendant terminal 23 includes a display device and is used by the sales clerk to monitor the content input to each accounting machine 21, and the like. Specifically, the attendant terminal 23 displays, on the display device, information being processed by each accounting machine 21 for each accounting machine 21 in real time. The information displayed on the display device includes product sales data of the transaction for which a payment has been made using the accounting machine 21, such as a product name, a price, and the number of products. Further, the total amount (amount of paid money) of the transaction, the payment amount for each payment method, and the like are also displayed on the display device. The attendant terminal 23 may be a handy terminal held by the sales clerk. By using a handy terminal as the attendant terminal 23, the sales clerk does not necessarily need to be resident in the attendant counter.

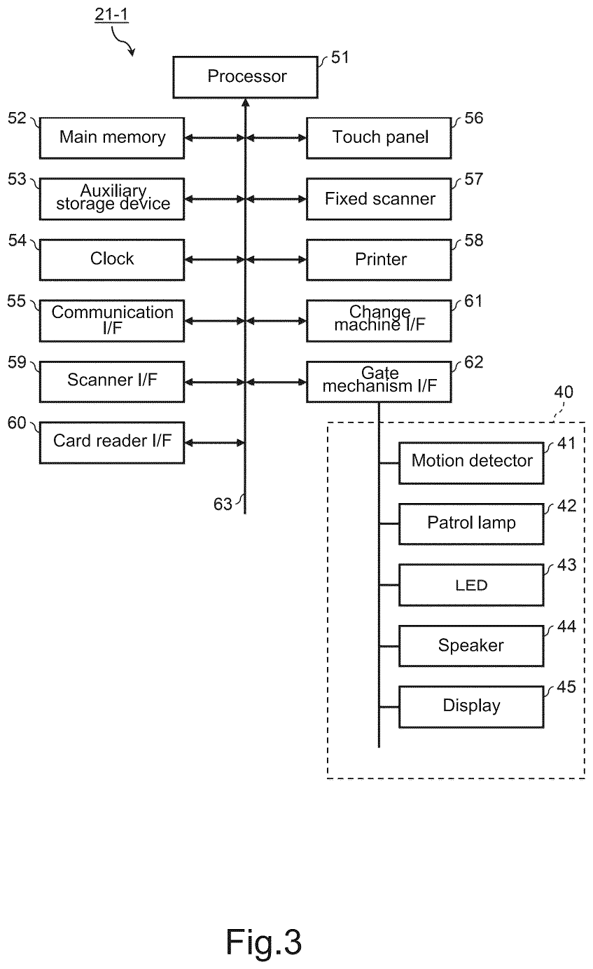

FIG. 3 is a block diagram showing a main circuit configuration of the first accounting machine 21-1 and the gate mechanism 40 constituting a gate device. The first accounting machine 21-1 includes a processor 51, a main memory 52, an auxiliary storage device 53, a clock 54, a communication interface 55, a touch panel 56, a fixed scanner 57, a printer 58, a scanner interface 59, a card reader interface 60, a change machine interface 61, a gate mechanism interface 62, a system transmission path 63, and the like. The system transmission path 63 includes an address bus, a data bus, a control signal line, and the like. The system transmission path 63 connects the processor 51 to other units and transmits data signals exchanged between them.

The first accounting machine 21-1 connects the processor 51 to the main memory 52, the auxiliary storage device 53, the clock 54, and the communication interface 55 via the system transmission path 63 to constitute a computer. The function of the first accounting machine 21-1 is realized by connecting an input/output device such as the touch panel 56, the fixed scanner 57, and the printer 58 and a device interface such as the scanner interface 59, the card reader interface 60, the change machine interface 61, and the gate mechanism interface 62 to the system transmission path 63 and controlling them with the computer. Note that the input/output device or device interface connected to the system transmission path 63 is not limited to those described above. For example, another input/output device such as a keyboard may be connected, or an interface such as a cashless payment terminal may be connected.

The processor 51 corresponds to the brain of the above computer. The processor 51 controls the respective units to realize various functions as a gate device in accordance with an operating system or an application program. The processor 51 is, for example, a central processing unit (CPU). The processor 51 is favorably a multi-core processor that includes a plurality of processor cores and is capable of executing a plurality of processes in parallel.

The main memory 52 corresponds to the main memory of the above computer. The main memory 52 has a non-volatile memory area and a volatile memory area. The main memory 52 stores an operating system or an application program in the non-volatile memory area. The main memory 52 stores data for the processor 51 to execute processing to control the respective units in the non-volatile or volatile memory area in some cases. The main memory 52 use the volatile memory area as a work area where data is rewritten by the processor 51 as appropriate. The non-volatile memory area is, for example, a read only memory (ROM). The volatile memory area is, for example, a random access memory (RAM).

The auxiliary storage device 53 corresponds to the auxiliary memory of the above computer. For example, the auxiliary storage device 53 can include an electric erasable programmable read-only memory (EEPROM (registered trademark)), a hard disk drive (HDD), or a solid state drive (SSD). The auxiliary storage device 53 stores data to be used by the processor 51 for performing various types of processing, data created by processing in the processor 51, and the like. The auxiliary storage device 53 stores the above application program in some cases.

The clock 54 measures the date and time. The processor 51 processes the date and time measured by the clock 54 as the current date and time.

The communication interface 55 is an interface for performing data communication between the store server 22, the attendant terminal 23, the communication server 31, and the like connected to the communication network 24.

The touch panel 56 includes a display that functions as a display device of the first accounting machine 21-1 and a touch sensor that functions as an input device. The touch panel 56 displays various types of information on the display to a customer who is a user of the first accounting machine 21-1 or a sales clerk. The touch panel 56 detects a touch operation on the screen of the display with the touch sensor and accepts an input corresponding to the touch position.

The fixed scanner 57 is an input device that scans and reads a computer-readable code such as a barcode and a two-dimensional code. The fixed scanner 57 is capable of reading the accounting barcode or the like that is printed on the receipt issued from the second accounting machine 21-2 or displayed on the display of the mobile terminal 11. The fixed scanner 57 is also capable of reading a computer-readable code printed on the ID card carried by the sales clerk. A computer-readable code indicating the identification code unique to the sales clerk, a so-called sales clerk code, is printed on the ID card carried by the sales clerk.

The printer 58 is a printing device for printing and issuing a receipt. The receipt is a paper medium that records the details of the transaction such as the transaction number, the transaction date and time, the product sales data, the total data, and the payment data.

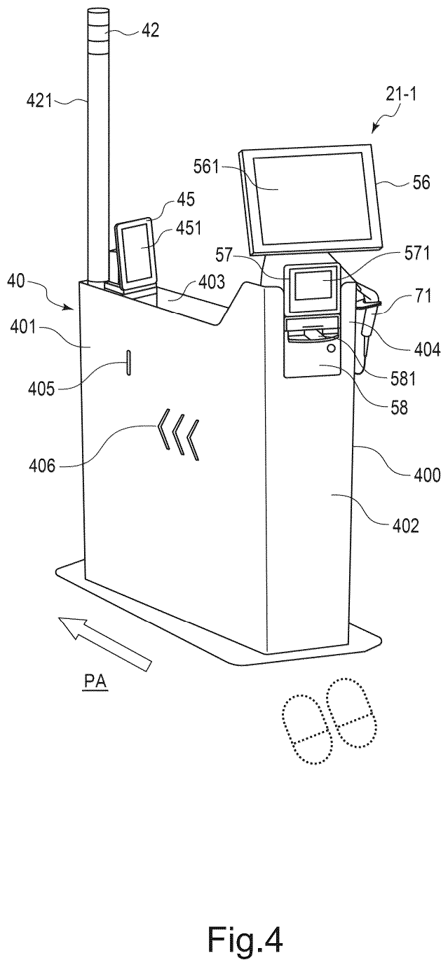

The scanner interface 59 is an interface that is capable of performing data communication with a handy scanner 71 (see FIG. 4). The handy scanner 71 is a portable scanner and is an input device that scans and reads a computer-readable code, similarly to the fixed scanner 57.

The card reader interface 60 is an interface that is capable of performing data communication with a card reader. The card reader is an input device that reads data recorded on a card medium such as a credit card, an electronic money card, and a rewards card. The card reader may be an IC card reader that reads data of an IC card, or a magnetic card reader that reads data of a magnetic card. The IC card reader may be a contact IC card reader or a non-contact IC card reader.

The change machine interface 61 is an interface that is capable of performing data communication with an automatic change machine capable of depositing a deposit and dispensing a change.

The gate mechanism interface 62 is an interface that is capable of performing data communication with a device included in the gate mechanism 40, such as a motion detector 41, a patrol lamp 42, an LED 43, a speaker 44, and a display 45.

### Description of Configuration of Gate Mechanism

FIG. 4 is a perspective view showing an example of the gate mechanism 40 associated with the first accounting machine 21-1 on a one-to-one basis. The gate mechanism 40 includes a casing 400 having a substantially rectangular parallelepiped shape. The casing 400 is disposed along a passage PA through which a customer moves in the direction indicated by an arrow in FIG. 4. The passage PA has an entrance on the side where a customer moving in the direction indicated by the arrow in FIG. 4 enters and an exit on the side from which the customer leaves. For example, a customer who has entered through the entrance can exit the store to the outside by going out of the exit through the passage PA. Alternatively, a customer can move from one part of the store to another.

Of four surfaces of the casing 400 extending upward from the four sides of the surface grounded to the floor surface of the passage PA, one surface disposed along the passage PA is a side surface 401, one surface facing the inside of the store is a front surface 402, and one surface opposed to the surface grounded to the floor surface of the passage PA is an upper surface 403. The joint between the front surface 402 and the upper surface 403 is a holder 404 of the first accounting machine 21-1.

The holder 404 holds the printer 58, the fixed scanner 57, and the touch panel 56 of the first accounting machine 21-1. Specifically, the holder 404 holds the printer 58 such that an issuing port 581 of a receipt is on the side of the front surface 402. The holder 404 holds the fixed scanner 57 such that a reading window 571 is on the side of the front surface 402 in the upper part of the printer 58. The holder 404 holds the touch panel 56 such that a screen 561 is on the side of the front surface 402 in the upper part of the fixed scanner 57. With such arrangement, for example, a customer standing in front of the gate mechanism 40 can easily receive a receipt issued from the issuing port 581. Further, a customer can easily hold the accounting barcode or the like over the reading window 571 of the fixed scanner 57. Further, a customer can perform a touch operation while viewing an image displayed on the touch panel 56.

A handy scanner connected to the scanner interface 59, a so-called handy scanner 71, is locked on the side surface opposite to the side surface 401 of the holder 404. Further, although not shown, the card reader connected to the card reader interface 60, the automatic change machine connected to the change machine interface 61, and the like are also disposed near the casing 400. For example, the card reader may be disposed on the upper surface 403 of the casing 400.

The patrol lamp 42 and the display 45 are mounted on the upper surface 403 of the casing 400. The patrol lamp 42 is an example of a light emitter. The patrol lamp 42 is provided on the top of a pole 421, which is mounted vertically to the floor surface, on the upper surface 403 closer to the surface opposite to the front surface 402 of the casing 400, a so-called back surface. The display 45 is disposed on the front side of this pole 421 such that a screen 451 faces the side of the front surface 402. The display 45 may be a display device with a screen smaller than that of the touch panel 56.

The motion detector 41, the LED 43, and the speaker 44 are built in the casing 400. In the casing 400, a slit 405 for the motion detector 41 and a slit 406 for the LED 43 are formed on the side surface 401 along the passage PA. The motion detector 41 is an infrared sensor that detects the movement or heat of a person passing through the position of the slit 405. The motion detector 41 may detect a person passing through the position of the slit 405 by a method other than a method using infrared rays. The motion detector 41 is an example of a detector that detects a person passing through the passage PA. The LED 43 turns on or blinks in a predetermined color and pattern such that light for guiding a customer to move through the passage PA in the direction indicated by the arrow leaks from the slit 406. Note that the detector does not necessarily need to be built in the casing 400 and may be provided separately from the gate mechanism 40. For example, the detector may be mounted on a device separate from the gate mechanism 40 and detect a person passing through the passage PA. For example, in the case where the detector is a camera, a person passing through the passage PA is detected by image recognition, and the detection result of the camera is transmitted to the gate mechanism 40 or the first accounting machine 21-1. The gate mechanism 40 detect a person passing through the passage PA by receiving the detection result from the camera.

Hereinafter, the entrance side where a customer enters in the passage PA, i.e., the side where the touch panel 56, the fixed scanner 57, and the like are provide, will be referred to as upstream, and the exit side opposite thereto, i.e., the side where the display 45, the patrol lamp 42, and the like are provided, will be referred to as downstream. Note that the position where the patrol lamp 42 is provided is not limited to the downstream side of the passage PA. The patrol lamp 42 may be provided in the center or upstream side of the passage PA.

The first accounting machine 21-1 provided in the casing 400 so as to correspond to the gate mechanism 40 with such a configuration on a one-to-one basis is an example of a payment apparatus that is capable of make a payment for a transaction with a customer upstream of the passage PA through which the customer moves in the direction indicated by the arrow in FIG. 4. Note that the positional relationship of the touch panel 56, the fixed scanner 57, the printer 58, and the like constituting the first accounting machine 21-1 with the casing 400 is not limited to that shown in FIG. 4. In short, the touch panel 56, the fixed scanner 57, the printer 58, and the like only need to be disposed at a position where a customer located upstream of the passage PA can easily operate them.

### Description of Function of Gate Device

As shown in FIG. 3, the processor 51 of the first accounting machine 21-1 also controls the gate mechanism 40 connected thereto via the gate mechanism interface 62. That is, the processor 51 of the first accounting machine 21-1 can be said to be the processor 51 of the gate device.

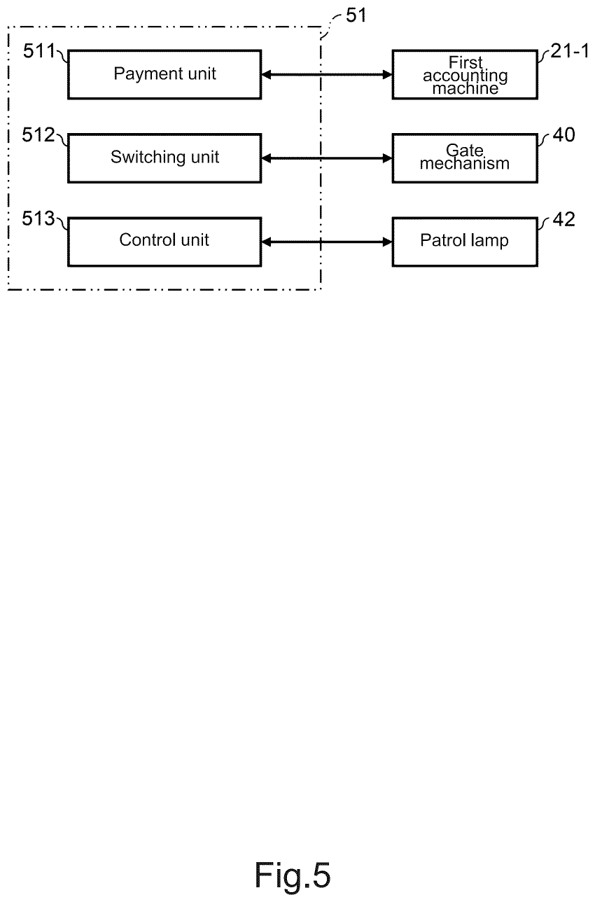

FIG. 5 is a schematic diagram showing a main functional configuration of the processor 51 of the gate device. The processor 51 has functions as a payment unit 511, a switching unit 512, and a control unit 513.

The payment unit 511 has a function of controlling the first accounting machine 21-1 upstream of the passage PA through which a customer who is a transaction target passes to make a payment for a transaction with the customer. For example, when the fixed scanner 57 reads a computer-readable code for code payment, the payment unit 511 executes code payment processing of paying for the transaction with the balance for code payment. For example, when the card reader reads an electronic money card, the payment unit 511 executes electronic money payment processing of paying for the transaction with electronic money. For example, when the card reader reads a credit card, the payment unit 511 executes credit card payment processing of paying for the transaction with the balance in the account. For example, when cash is inserted into an automatic change machine, the payment unit 511 executes cash payment processing of paying for the transaction with the input amount. Since the above payment processing is known processing, detailed description thereof is omitted here.

The switching unit 512 has a function of switching the operation mode of the gate mechanism 40 between a first mode and a second mode. The first mode is an operation mode in which notification is made when the motion detector 41 that is a detector detects a person passing through the passage PA. The second mode is an operation mode in which no notification is made even when the motion detector 41 detects a person passing through the passage PA. When the operation mode of the gate mechanism 40 is the first mode, the passage PA is impassible. When the operation mode of the gate mechanism 40 is the second mode, the passage PA is passable.

The control unit 513 has a function of changing the light emission state of the patrol lamp 42 that is a light emitter to different states between the first mode and the second mode. For example, the control unit 513 turns off the patrol lamp 42 in the first mode and makes the patrol lamp 42 blink blue in the second mode.

Further, the control unit 513 has a function of further changing the light emission state of the patrol lamp 42 while a payment is made by the payment unit 511. For example, the control unit 513 makes the patrol lamp 42 blink blue while a payment is made by the payment unit 511.

Further, the control unit 513 has a function of further changing the light emission state of the patrol lamp 42 when an event that calls a sales clerk occurs while a payment is made by the payment unit 511. The event that calls a sales clerk is, for example, when a product purchased by a customer includes a product that requires age verification such as an alcohol and a cigarette. Other examples of the event include a case where receipt paper housed in the printer 58 is near-end and a case where there are insufficient coins or bills for change housed in the automatic change machine. For example, the control unit 513 changes, when the event that calls a sales clerk occurs, the state of the patrol lamp 42 from the blue lighted state to the yellow lighted state. Further, in the case where the patrol lamp 42 is capable of lighting and displaying a plurality of colors, for example, the control unit 513 controls, when the event that calls a sales clerk occurs, the patrol lamp 42 to light up yellow in addition to blue. That is, the control unit 513 controls the patrol lamp 42 such that the lighted state thereof is the two-color lighted state of blue and yellow.

Further, the control unit 513 has a function of further changing the light emission state of the patrol lamp 42 when the motion detector 41 detects a person passing through the passage PA in the first mode. For example, the control unit 513 makes the patrol lamp 42 blink red when a person passing through the passage PA is detected in the first mode.

### Description of Operation of Gate Device

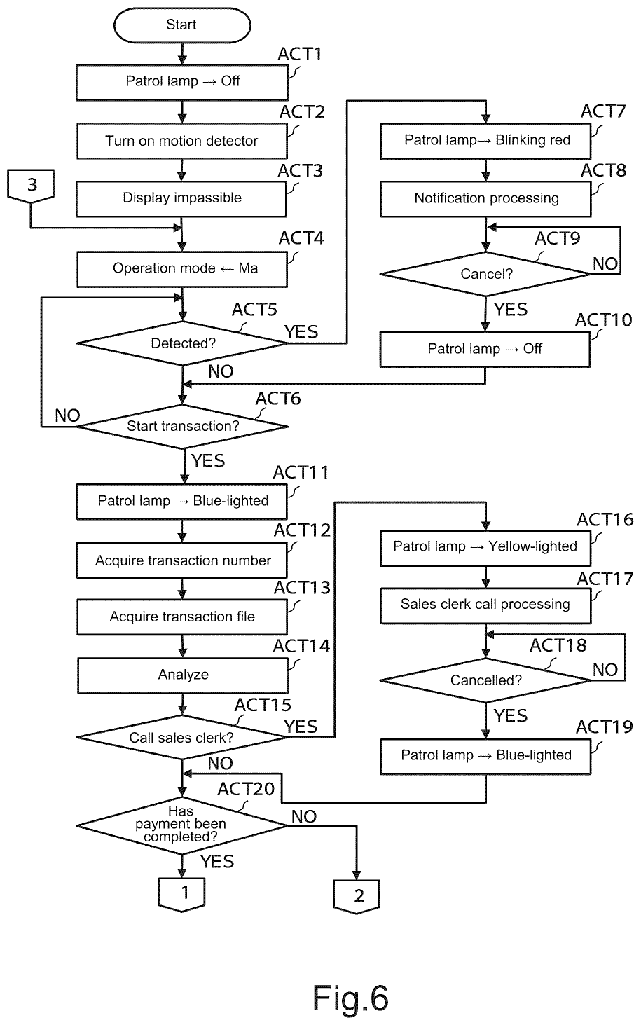

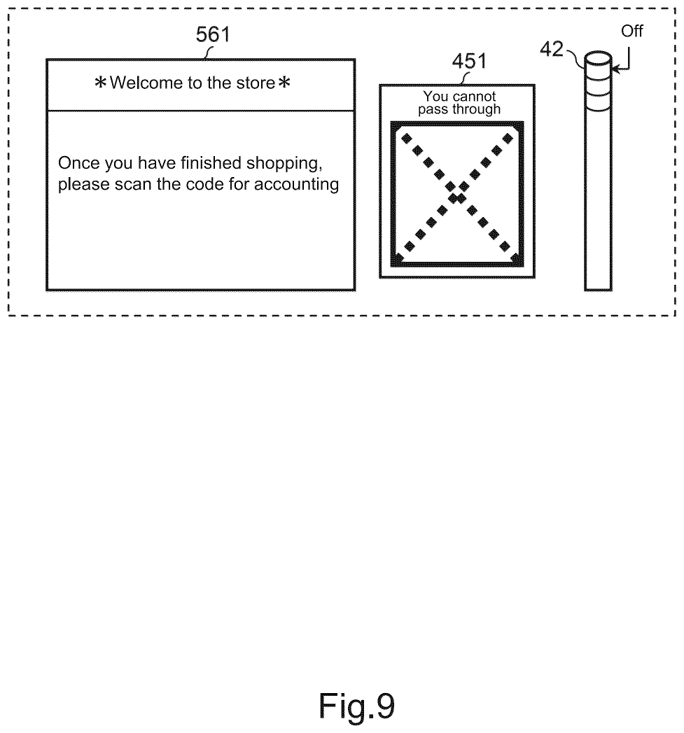

FIG. 6 to FIG. 8 are each a flowchart showing a procedure of main information processing executed by the processor 51 of the gate device in accordance with a gate device program. Further, FIG. 9 to FIG. 15 each show an example of an image displayed on the screen 561 of the touch panel 56 and the screen 451 of the display 45 in the information processing, and the light emission state of the patrol lamp 42. The main operation of the gate device will be described below with reference to the drawings. Note that the procedure of the information processing shown in the flowchart of FIG. 6 to FIG. 8 is an example. The procedure can be appropriately changed as long as the same operation and effect as those in this embodiment can be achieved. Further, the image and light emission state shown in FIG. 9 to FIG. 15 are also examples. The content of the image and light emission state can be appropriately changed as long as the same operation and effect as those in this embodiment can be achieved.

When the gate device program is activated, the processor 51 of the gate device starts the information processing in the procedure shown in the flowchart in FIG. 6 to FIG. 8. First, the processor 51 sets the light emission state of the patrol lamp 42 to of in ACT1 in FIG. 6. Further, in ACT2, the processor 51 turns on the motion detector 41 by energizing the motion detector 41. The motion detector 41 that has been turned on starts an operation for detecting a person passing through the passage PA, such as emitting infrared rays.

The processing of the processor 51 that has turned on the motion detector 41 proceeds to ACT3. In ACT3, the processor 51 controls display of an impassible image on the touch panel 56 and the display 45. This controls displays the impassible image shown in FIG. 9 on the screen 561 of the touch panel 56 and the screen 451 of the display 45. That is, a text that instructs a customer coming to the entrance side of the passage PA to scan the accounting barcode using the fixed scanner 57 is displayed on the screen 561 of the touch panel 56. For example, an illustration of a person holding the barcode over the fixed scanner 57 may be displayed together with the text. A text indicating that the passage PA is impassable and an image of a blinking “x” mark are displayed on the screen 451 of the display 45. At this time, the patrol lamp 42 is turned off.

In accordance with these indications, most customers will scan the accounting barcode using the fixed scanner 57 before entering the passage PA. The accounting barcode is displayed on the display device of the mobile terminal 11. Alternatively, for a customer who has completed the payment using the second accounting machine 21-2, the accounting barcode is printed on a receipt in some cases.

The processing of the processor 51 that has controlled the display of an impassible image proceeds to ACT4. In ACT4, the processor 51 sets the operation mode of the gate device to a first mode Ma. That is, the processor 51 sets the operation mode to a mode in which notification is made when the motion detector 41 detects a person passing through the passage PA. Then, in ACT5, the processor 51 checks whether or not a person passing through the passage PA has been detected by the motion detector 41. In the case where the signal of the motion detector 41 is an off signal and no person has been detected, the processing of the processor 51 proceeds to ACT6. In ACT6, the processor 51 checks whether or not an instruction to start a transaction has been made. The processor 51 determines, when the accounting barcode is scanned using the fixed scanner 57, that an instruction to start a transaction has been made. In the case where no accounting barcode is scanned, i.e., no instruction to start a transaction has been made, the processing of the processor 51 returns to ACT5. In this way, in ACT5 and ACT6, the processor 51 that has set the operation mode to the first mode Ma stands by until a person passing through the passage PA is detected or an instruction to start a transaction is made.

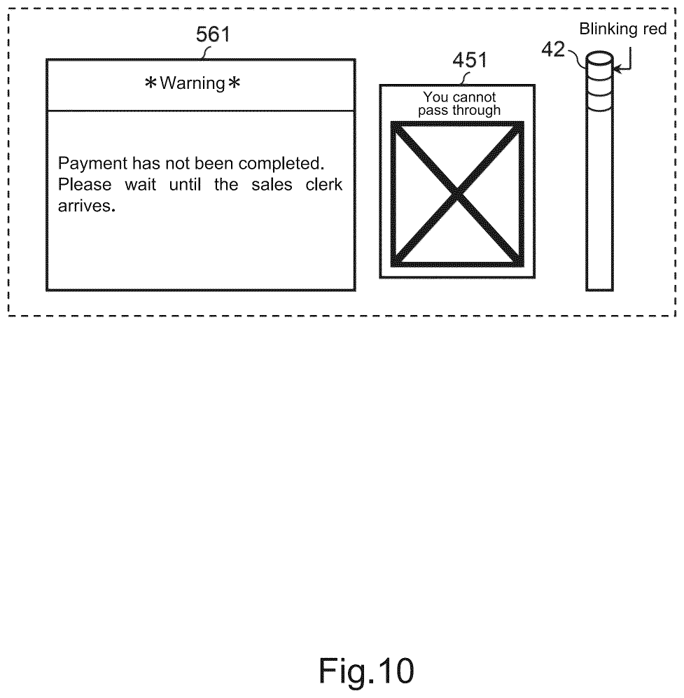

When the signal of the motion detector 41 is an on signal before an instruction to start a transaction is made in the stand-by state in ACT5 and ACT6, the processor 51 determines that a person illegally passing through the passage PA has been detected. The processing of the processor 51 proceeds to ACT7. In ACT7, the processor 51 sets the light emission state of the patrol lamp 42 to blinking red. Further, in ACT8, the processor 51 executes notification processing. The notification processing is processing of transmitting a notification signal to the attendant terminal 23. Further, the notification processing includes processing of displaying a warning image on the touch panel 56 and the display 45. This processing displays the warning image shown in FIG. 10 on the screen 561 of the touch panel 56 and the screen 451 of the display 45. That is, a text, illustration, or the like indicating that the payment has not been completed is displayed on the screen 561 of the touch panel 56. The image of the blinking “x” mark enters the lighted state on the screen 451 of the display 45. At this time, the patrol lamp 42 is blinking red. A sound for warning may be emitted from the speaker 44.

The attendant terminal 23 that has received the notification signal notifies an attendant of that a warning for illegal passing has been issued in the gate device. When receiving this notification, a sales clerk who is the attendant goes to the location of the gate mechanism 40 where the patrol lamp 42 blinks red and takes action against the illegal passing. For example, the sales clerk identifies the person who made the illegal passing and takes action. After that, the sales clerk causes the handy scanner 71 to read the sales clerk code printed on the ID card in the form of a computer-readable code. Once the sales clerk code is read, the operation mode of the gate device is temporarily switched to a sales clerk mode. When the operation mode is switched to the sales clerk mode, the gate device is capable of cancelling the notification processing. The sales clerk cancels the notification processing by, for example, operating the touch panel 56. When the notification processing is cancelled, the operation mode of the gate device returns to the first mode Ma.

The processing of the processor 51 that has performed the notification processing in ACT8 proceeds to ACT9. In ACT9, the processor 51 stands by until the notification processing is cancelled. The notification processing is then cancelled when, for example, an instruction to cancel the notification processing is input via the display 45 of the gate mechanism 40 or the touch panel 56 of the first accounting machine 21-1. For example, the sales clerk causes the fixed scanner 57 of the first accounting machine 21-1 to read the barcode held by the sales clerk to cause the first accounting machine 21-1 to enter the sales clerk mode. In this sales clerk mode, the sales clerk touches the icon for cancelling notification displayed on the display 45 or the touch panel 56 to cancel the notification processing. Note that the cancelling of notification processing is not limited thereto. When the notification processing is cancelled, the processing of the processor 51 proceeds to ACT10. In ACT10, the processor 51 sets the light emission state of the patrol lamp 42 to off. Further, the processor 51 returns the states of the screen 561 of the touch panel 56 and the screen 451 of the display 45 to the states of displaying the impassible image shown in FIG. 9. After that, the processor 51 returns to the stand-by state in ACT5 and ACT6.

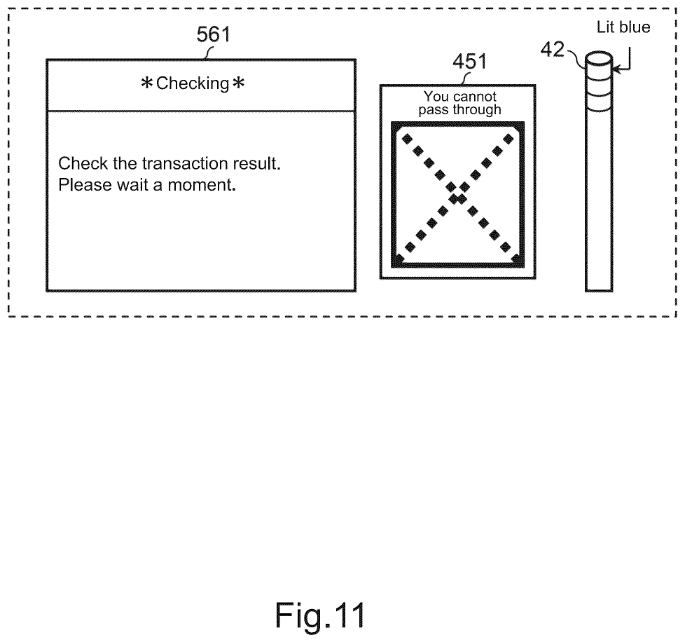

When the accounting barcode is scanned by the fixed scanner 57 in the stand-by state in ACT5 and ACT6, the processor 51 determines that an instruction to start a transaction has been made. The processing of the processor 51 proceeds to ACT11. In ACT11, the processor 51 sets the light emission state of the patrol lamp 42 to blue-lighted. Further, the processor 51 controls the display of a checking image on the touch panel 56. This control displays the checking image shown in FIG. 11 on the screen 561 of the touch panel 56. The checking image is an image displaying a text, illustration or the like indicating that the transaction result is being checked. Note that the state of blinking the image of the “x” mark is continued on the screen 451 of the display 45. The patrol lamp 42 is lit blue.

In ACT12, the processor 51 acquires the transaction number from the accounting barcode. As described above, the accounting barcode may be one displayed on the display device of the mobile terminal 11 or one printed on the receipt. The processing of the processor 51 that has acquired the transaction number proceeds to ACT13. In ACT13, the processor 51 acquires the transaction file 16. That is, the processor 51 outputs a request command for requesting the transaction file 16 to the mobile server 12. The request command includes the transaction number acquired in ACT12. The mobile server 12 that has received the request command detects the transaction file 16 in which the transaction number included in the command is described and transmits the detected transaction file 16 to the gate device that is the source of the request command. In this way, the processor 51 is capable of acquiring the transaction file 16.

The processing of the processor 51 that has acquired the transaction file 16 proceeds to ACT14. In ACT14, the processor 51 analyzes the transaction file 16 to examine the product sales data. In ACT15, the processor 51 checks whether or not product sales data of a product that requires calling a sales clerk has been described. The product that requires calling a sales clerk is, for example, a product that requires age verification such as an alcohol and a cigarette. The product that requires calling a sales clerk may be a product other than the product that requires age verification.

In the case where product sales data of a product that requires calling a sales clerk is not described in the transaction file 16, the processing of the processor 51 proceeds to ACT20. The processing of ACT20 will be described below.

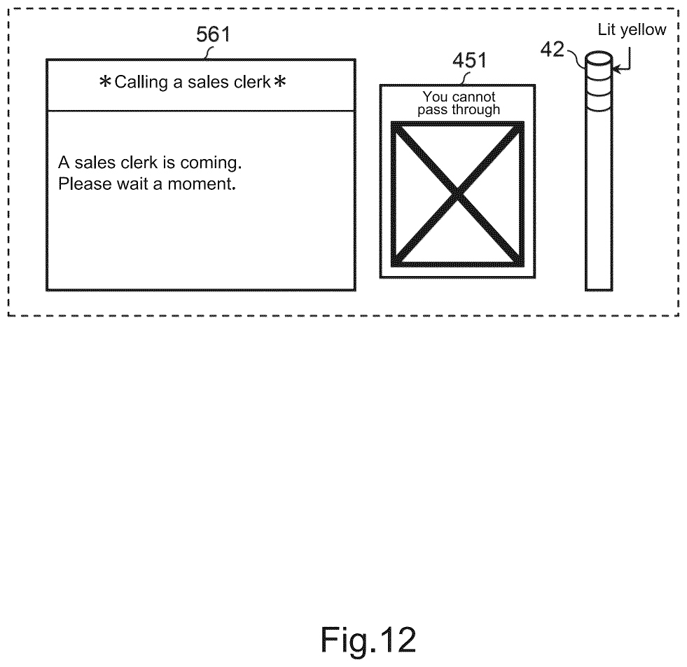

Meanwhile, in the case where product sales data of a product that requires calling a sales clerk is described in the transaction file 16, the processing of the processor 51 proceeds to ACT16. In ACT16, the processor 51 sets the light emission state of the patrol lamp 42 to yellow-lighted. Further, in ACT17, the processor 51 executes sales clerk call processing. The sales clerk call processing is processing of transmitting a sales clerk call signal to the attendant terminal 23. Further, the sales clerk call processing includes processing of displaying a sales clerk call image on the touch panel 56 and the display 45. This processing displays the sales clerk call image shown in FIG. 12 on the screen 561 of the touch panel 56 and the screen 451 of the display 45. That is, a text, illustration, or the like indicating that a sales clerk is being called is displayed on the screen 561 of the touch panel 56. The image of the blinking “x” mark enters a lighted state on the screen 451 of the display 45. At this time, the patrol lamp 42 is lit yellow. A sound for attention may be emitted from the speaker 44. The sound for attention may be the same as or different from the sound for warning. For example, the sound for warning may be a continuous “beep” sound and the sound for attention may be an intermittent “beep, beep” sound.

The attendant terminal 23 that has received the sales clerk call signal notifies the attendant of that a call is being received. For example, the attendant terminal 23 performs, upon receiving the sales clerk call signal, the notification by displaying a message indicating that a sales clerk call is being received in the gate device on the display of the attendant terminal 23. Upon receiving this notification, the sales clerk who is the attendant goes to the location of the gate mechanism 40 where the patrol lamp 42 is lit yellow and performs age verification or the like. After that, the sales clerk causes the handy scanner 71 to read the sales clerk code printed on the ID card in the form of a computer-readable code. Once the sales clerk code is read, the operation mode of the gate device is temporarily switched to the sales clerk mode. When the operation mode is switched to the sales clerk mode, the gate device is capable of cancelling the sales clerk call processing. The sales clerk cancels the sales clerk call processing by, for example, operating the touch panel 56. When the sales clerk call processing is cancelled, the operation mode of the gate device returns to the first mode Ma.

The processing of the processor 51 that has performed the sales clerk call processing in ACT17 proceeds to ACT18. In ACT18, the processor 51 stands by until the sales clerk call processing is cancelled. When the sales clerk call processing is cancelled, the processing of the processor 51 proceeds to ACT19. In ACT19, the processor 51 sets the light emission state of the patrol lamp 42 to blue-lighted. Further, the processor 51 returns the states of the screen 561 of the touch panel 56 and the screen 451 of the display 45 to the states of displaying the checking image shown in FIG. 11. After that, the processing of the processor 51 proceeds to ACT20.

When, as a result of analyzing the transaction file 16, product sales data of a product that requires calling a sales clerk is not included or sales clerk call processing is executed because product sales data of a product that requires calling a sales clerk is included and then the sales clerk call processing is cancelled, as described above, the processing of the processor 51 proceeds to ACT20.

In ACT20, the processor 51 checks whether or not the payment has been completed. That is, the processor 51 examines the payment completion flag Fa described in the transaction file 16. The payment completion flag Fa is “1” in the case where the payment for the transaction managed by the transaction file 16 has been completed using the mobile terminal 11 or the second accounting machine 21-2, which is another payment means, and “0” in the case where the payment has not been completed. The processor 51 determines, in the case where the payment completion flag Fa is “0”, that the payment has not been completed. The processor 51 determines, in the case where the payment completion flag Fa is “1”, that the payment has been completed.

### Operation for Customer who has Completed Payment Using Another Payment Means

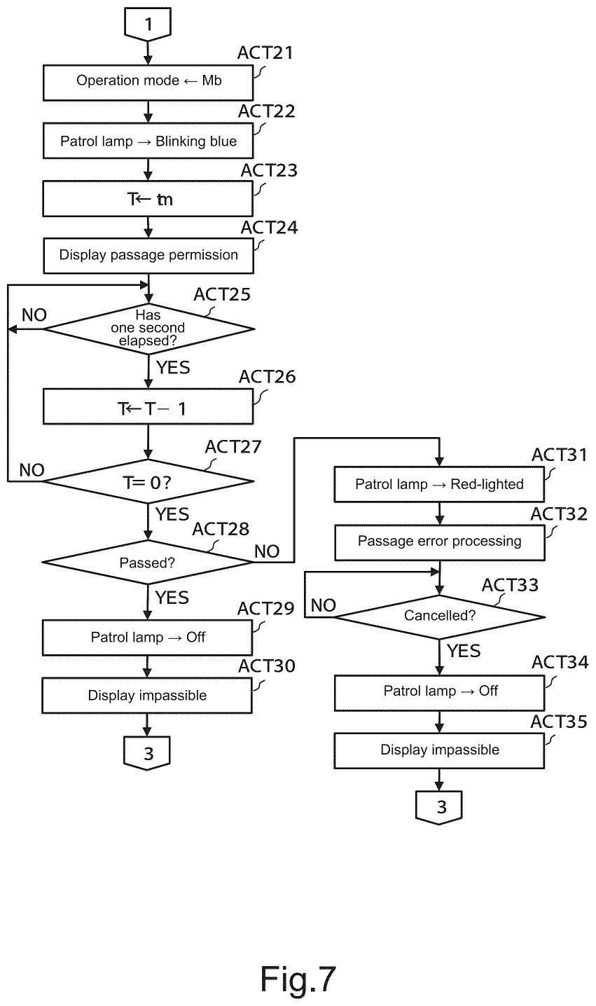

In the case where it is determined in ACT20 that the payment has been completed, the processing of the processor 51 proceeds to ACT21 in FIG. 7. In ACT21, the processor 51 sets the operation mode of the gate device to a second mode Mb. That is, the processor 51 sets the operation mode to a mode in which no notification is made even when the motion detector 41 detects a person passing through the passage PA. Further, in ACT21, the processor 51 sets the light emission state of the patrol lamp 42 to blinking blue.

After that, the processing of the processor 51 proceeds to ACT23. In ACT23, the processor 51 sets a time counter T to a time Tm that is a first initial value. The time counter T is a subtraction counter that subtracts “1” from the count value each time one second elapses. The time Tm is a time that is assumed to be required for a customer who has completed the payment using devices other than the gate device to pass through the passage PA. That is, the time Tm is a predetermined time that is assumed to be required for a customer who has completed the payment using a payment application installed in the mobile terminal 11 or a customer who has completed the payment using the second accounting machine 21-2 to pass through the passage PA. The time Tm is arbitrary. In this embodiment, the time Tm is 10 seconds.

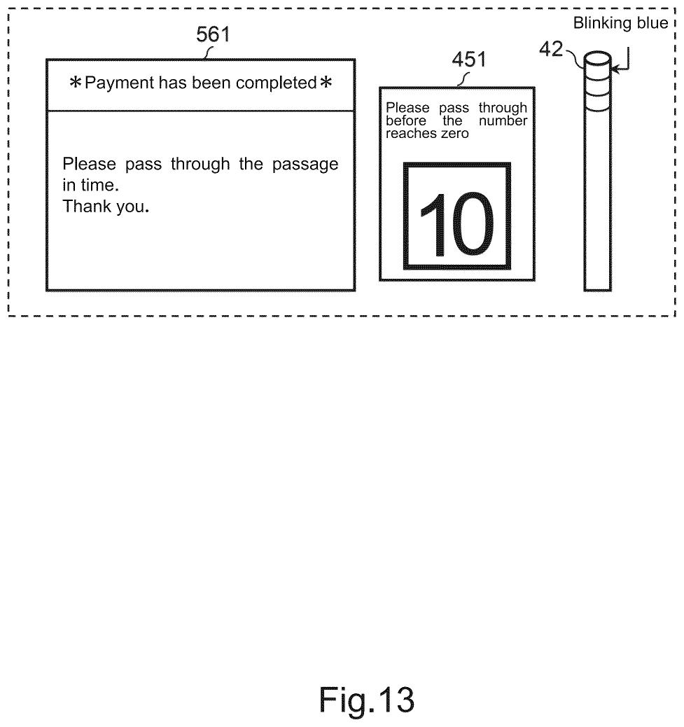

The processing of the processor 51 that has set the time counter T to the time Tm proceeds to ACT24. In ACT24, the processor 51 controls the display of the passage permission image on the touch panel 56 and the display 45. This controls displays the passage permission image shown in FIG. 13 on the screen 561 of the touch panel 56 and the screen 451 of the display 45. That is, a text, illustration, or the like indicating that a customer is permitted to pass through the passage is displayed on the screen 561 of the touch panel 56. A number indicating the count value of the time counter T and a text urging the customer to pass through the passage before the number reaches “0” are displayed on the screen 451 of the display 45. Further, the LED 43 emits light such that light for guiding a customer to move through the passage PA in the direction indicated by the arrow leaks from the slit 406. At this time, the patrol lamp 42 blinks blue. In accordance with these indications, a customer who has completed the transaction will pass through the passage PA before the count value of the time counter T reaches “0”.

The processing of the processor 51 that has controlled the display of a passage permission image proceeds to ACT25. In ACT25, the processor 51 stands by until one second to elapse in the time measured by the clock 54. When one second has elapsed, the processing of the processor 51 proceeds to ACT26. In ACT26, the processor 51 subtracts the time counter T by “1”. Then, in ACT27, the processor 51 checks whether or not the time counter T has reached “0”. In the case where the time counter T is greater than “0”, the processing of the processor 51 returns to ACT25.

In this way, the processor 51 that has set the operation mode to the second mode Mb stands by until the time counter T reaches “0”, in ACT25 to ACT27. In the meantime, the processor 51 subtracts the number displayed on the screen 451 of the display 45 in accordance with the time counter T. Further, the processor 51 does not perform notification processing even if the motion detector 41 detects a person passing through the passage PA.

When the time counter T reaches “0” in the stand-by state in ACT25 to ACT27, the processing of the processor 51 proceeds to ACT28. In ACT28, the processor 51 determines whether or not a person has passed through the passage PA in the stand-by state. The processor 51 determines, in the case where the motion detector 41 has detected a person in the stand-by state and then the person is no longer detected, that the person has passed through the passage PA. Meanwhile, in the case where no person is detected in the stand-by state, the processor 51 determines that no person has passed through the passage PA. Further, also in the case where a person stays in the middle of the passage PA and the person continues to be detected by the motion detector 41, the processor 51 determines that no person has passed through the passage PA.

In the case where it is determined that a person has passed through the passage PA in the stand-by state, the processing of the processor 51 proceeds to ACT29. In ACT29, the processor 51 sets the light emission state of the patrol lamp 42 to off. Further, in ACT30, the processor 51 controls the display of an impassible image on the touch panel 56 and the display 45. This control displays the impassible image shown in FIG. 9 on the screen 561 of the touch panel 56 and the screen 451 of the display 45. Further, the patrol lamp 42 is turned off. After that, the processing of the processor 51 returns to ACT4 in FIG. 6. The processor 51 sets the operation mode of the gate device to the first mode Ma to enter the stand-by state in ACT5 and ACT6.

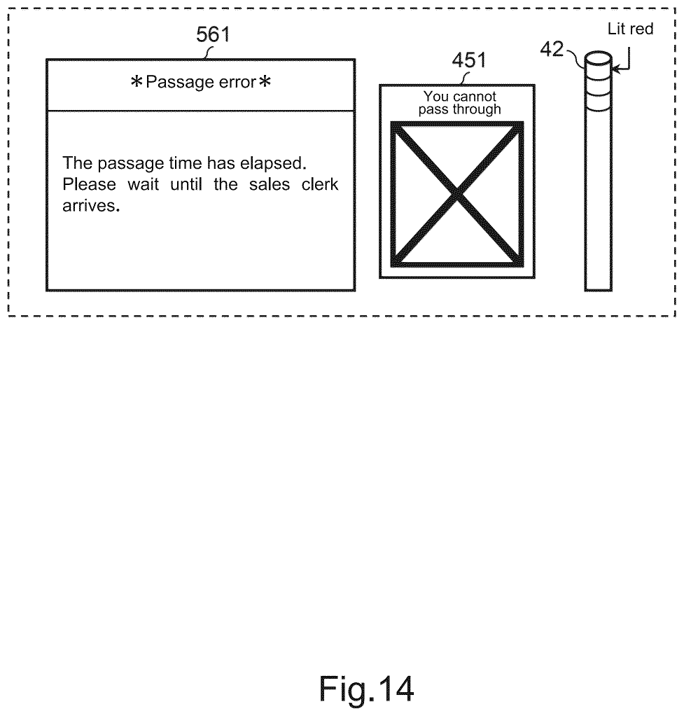

Meanwhile, in the case where the time counter T has reached “0” without a person passing through the passage PA, the processing of the processor 51 proceeds to ACT31. It is conceivable that in the case where the time counter T has reached “0” without a person passing through the passage PA, an event that a customer who has been permitted to pass through the passage PA cannot pass through the passage PA due to some trouble has occurred. In this regard, in ACT31, the processor 51 sets the light emission state of the patrol lamp 42 to red-lighted. Further, in ACT32, the processor 51 executes passage error processing. This passage error processing transmits a passage error signal to the attendant terminal 23. Further, the passage error processing includes processing of displaying a passage error image on the touch panel 56 and the display 45. This processing displays the passage error image shown in FIG. 14 on the screen 561 of the touch panel 56 and the screen 451 of the display 45. That is, a text, illustration, or the like indicating that a passage error has occurred because the passage time has elapsed is displayed on the screen 561 of the touch panel 56. The image of the “x” mark is displayed in the lighted state on the screen 451 of the display 45. At this time, the patrol lamp 42 is lit red. A sound for the passage error may be emitted from the speaker 44. The sound for the passage error may be the same as or different from the sound for warning.

The attendant terminal 23 that has received the passage error signal notifies that a passage error has occurred in the gate device. Upon receiving this notification, the sales clerk who is the attendant goes to the location of the gate mechanism 40 where the patrol lamp 42 is lit red and takes action against the passage error. For example, the sales clerk asks the customer why the passage error has occurred and attempts to resolve the problem. After that, the sales clerk causes the handy scanner 71 to read the sales clerk code printed on the ID card in the form of a computer-readable code. Once the sales clerk code is read, the operation mode of the gate device is temporarily switched to the sales clerk mode. When the operation mode is switched to the sales clerk mode, the gate device is capable of cancelling the passage error processing. The sales clerk cancels the passage error processing by, for example, operating the touch panel 56. When the passage error processing is cancelled, the operation mode of the gate device returns to the first mode Ma.

The processing of the processor 51 that has performed the passage error processing proceeds to ACT33. In ACT33, the processor 51 stands by until the passage error processing is cancelled. When the passage error processing is cancelled, the processing of the processor 51 proceeds to ACT34. In ACT34, the processor 51 sets the light emission state of the patrol lamp 42 to off. Further, in ACT35, the processor 51 controls the display of an impassible image on the touch panel 56 and the display 45. This controls displays the impassible image shown in FIG. 9 on the screen 561 of the touch panel 56 and the screen 451 of the display 45. The patrol lamp 42 is turned off. After that, the processing of the processor 51 returns to ACT4 in FIG. 6. The processor 51 sets the operation mode of the gate device to the first mode Ma to enter the stand-by state in ACT5 and ACT6.

### Operation for Customer who has not Completed Payment Using Another Payment Means

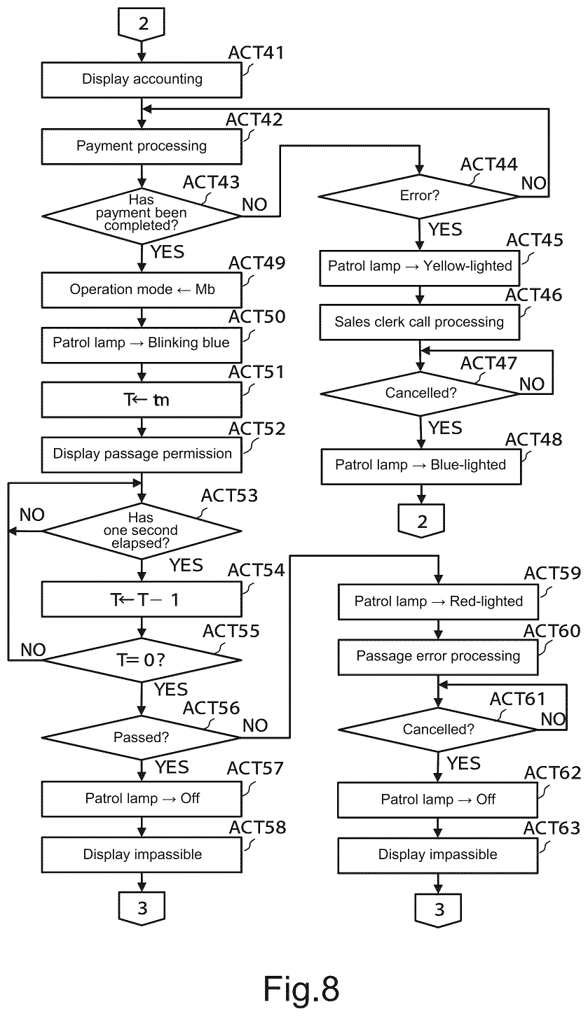

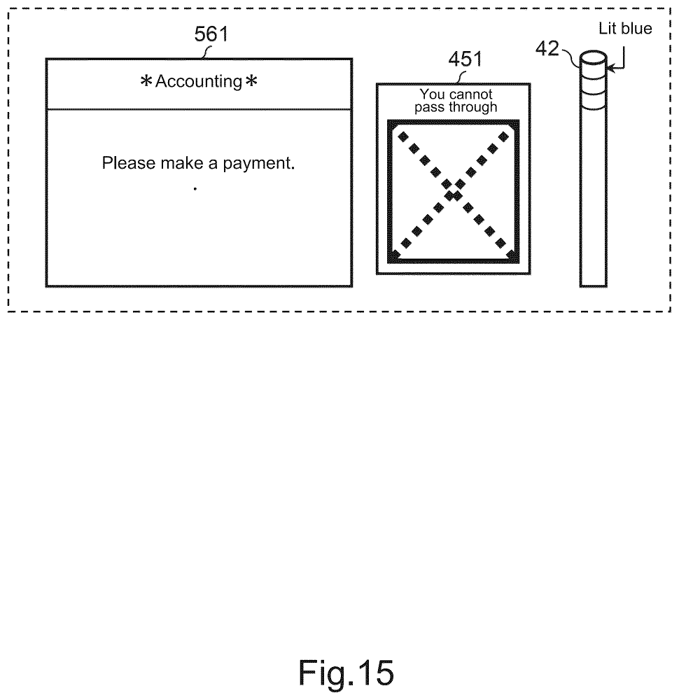

In the case where it is determined in ACT20 in FIG. 6 that the payment has not been completed, the processing of the processor 51 proceeds to ACT41 in FIG. 8. In ACT41, the processor 51 controls the display of an accounting image on the touch panel 56 and the display 45. This control displays the accounting image shown in FIG. 15 on the screen 561 of the touch panel 56 and the screen 451 of the display 45. That is, a text instructing a customer coming to the entrance side of the passage PA to make a payment is displayed on the screen 561 of the touch panel 56. For example, an illustration of a person inserting cash into an automatic change machine may be displayed together with the text. A text indicating that the customer cannot pass through the passage PA and an image of the blinking “x” mark are displayed on the screen 451 of the display 45. At this time, the patrol lamp 42 is lit blue.

The processing of the processor 51 that has controlled the display of an accounting image proceeds to ACT42. In ACT42, the processor 51 performs payment processing. The payment processing includes cashless payment such as code payment processing, electronic money payment processing, or credit card payment processing described above. The cashless payment is favorable in this embodiment because the time required for the payment processing is shorter than that in cash payment. Note that the payment processing may be cash payment processing in which payment for the transaction is made with the input amount.

In ACT43, the processor 51 stands by until the payment processing is completed. At this time, in ACT44, the processor 51 monitors whether or not an error has occurred during the payment processing. For example, when an error that the receipt paper of the printer 58 is near-end has occurred or an error such as a coin jam has occurred in the automatic change machine, the processing of the processor 51 proceeds to ACT45. In ACT45, the processor 51 sets the light emission state of the patrol lamp 42 to yellow-lighted. Further, in ACT46, the processor 51 executes sales clerk call processing. This sales clerk call processing transmits a sales clerk call signal to the attendant terminal 23. Further, the sales clerk call image shown in FIG. 12 are displayed on the screen 561 of the touch panel 56 and the screen 451 of the display 45. At this time, the patrol lamp 42 is lit yellow.

The attendant terminal 23 that has received the sales clerk call signal notifies the sales clerk who is the attendant of that a call is being received. Upon receiving this notification, the sales clerk goes to the location of the gate mechanism 40 where the patrol lamp 42 is lit yellow and takes action against the error that has occurred during the payment. For example, the sales clerk replaces the receipt paper or adds change coins. After that, the sales clerk switches the operation mode of the gate device to the sales clerk mode to perform an operation for cancelling the call.

The processing of the processor 51 that has performed the sales clerk call processing proceeds to ACT47. In ACT47, the processor 51 stands by until the sales clerk call processing is cancelled. When the sales clerk call processing is cancelled, the processing of the processor 51 proceeds to ACT48. In ACT48, the processor 51 sets the light emission state of the patrol lamp 42 to blue-lighted. After that, the processing of the processor 51 returns to ACT41. That is, the processor 51 controls the display of an accounting image on the touch panel 56 and the display 45. The processor 51 then continues the payment processing.

When the payment processing is completed, the processing of the processor 51 proceeds to ACT49. In ACT49, the processor 51 sets the operation mode of the gate device to the second mode Mb. That is, the processor 51 sets the operation mode to a mode in which no notification is made even when the motion detector 41 detects a person passing through the passage PA. Further, in ACT50, the processor 51 sets the light emission state of the patrol lamp 42 to blinking blue.

After that, the processing of the processor 51 proceeds to ACT51. In ACT51, the processor 51 sets the time counter T to a time In that is a second initial value. The time Tn is a time that is assumed to be required for a customer who has completed the payment using the gate device to pass through the passage PA. That is, the time Tn is a predetermined time that is assumed to be required for a customer who has completed the payment using the gate device to pass through the passage PA. Assumption is made that the customer who has completed the payment enters the passage PA after putting his/her smartphone, credit card, wallet, and the like in his/her bag. For this reason, although the time Tn is arbitrary similarly to the time Tm, the time In is favorably longer than the time Tm. In this embodiment, the time In is set to 15 seconds.

The processing of the processor 51 that has set the time counter T to the time In proceeds to ACT52. In ACT52, the processor 51 controls the display of a passage permission image on the touch panel 56 and the display 45. This control displays the passage permission image shown in FIG. 13 on the screen 561 of the touch panel 56 and the screen 451 of the display 45. Further, the LED 43 emits light such that light for guiding a customer to move through the passage PA in the direction indicated by the arrow leaks from the slit 406. At this time, the patrol lamp 42 is lit blue.

In accordance with these indications, the customer who has completed the transaction and put his/her smartphone, credit card, wallet, and the like in his/her bag will pass through the passage PA before the count value of the time counter T reaches “0”.

The processing of the processor 51 that has controlled the display of a passage permission image proceeds to ACT53. After that, in ACT53 to ACT63, the processor 51 executes the same processing as that in ACT25 to ACT35 in FIG. 7. That is, in the case where a person has passed through the passage PA while the time Tm is measured, the processor 51 sets the light emission state of the patrol lamp 42 to off. Further, the processor 51 controls the display of an impassible image on the touch panel 56 and the display 45. This control displays the impassible image shown in FIG. 9 on the screen 561 of the touch panel 56 and the screen 451 of the display 45. Further, the patrol lamp 42 is turned off. After that, the processing of the processor 51 returns to ACT4 in FIG. 6. The processor 51 sets the operation mode of the gate device to the first mode Ma to enter the stand-by state in ACT5 and ACT6.

Meanwhile, in the case where the time Tm has been measured without a person passing through the passage PA, the processor 51 sets the light emission state of the patrol lamp 42 to red-lighted and executes passage error processing. After that, when the passage error processing is cancelled, the processor 51 sets the light emission state of the patrol lamp 42 to off. Further, the processor 51 controls the display of an impassible image on the touch panel 56 and the display 45. This controls displays the impassible image shown in FIG. 9 on the screen 561 of the touch panel 56 and the screen 451 of the display 45. Further, the patrol lamp 42 is turned off. After that, the processing of the processor 51 returns to ACT4 in FIG. 6. The processor 51 sets the operation mode of the gate device to the first mode Ma to enter the stand-by state in ACT5 and ACT6.

### Description of State Transition of Patrol Lamp

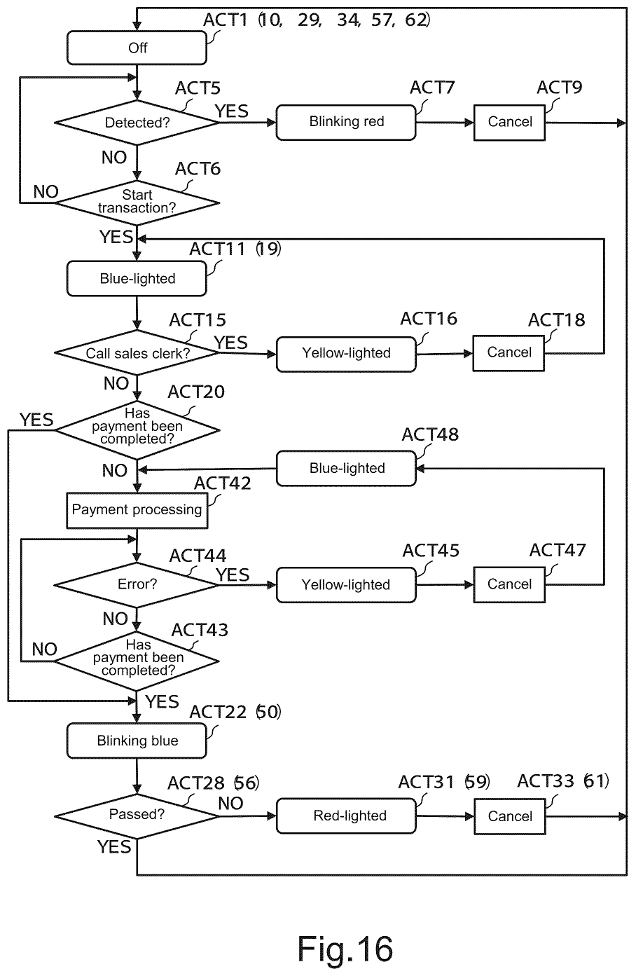

FIG. 16 is a diagram describing the state transition of the patrol lamp 42. Note that the operations common to those described with reference to FIG. 6 to FIG. 8 are denoted by the same reference symbols. The patrol lamp 42 is turned off in the default stand-by state (ACT1). When a person passing through the passage PA is detected in this stand-by state (YES in ACT5), the patrol lamp 42 blinks red (ACT7). For this reason, the sales clerk who has confirmed that the patrol lamp 42 blinks red can know that illegal passing that a customer leaves the store without making a payment has been detected in the gate device where this patrol lamp 42 is provided. The sales clerk takes action against the illegal passing. When the action is completed (ACT9), the patrol lamp 42 is turned off (ACT10). For this reason, when the patrol lamp that has been lit red is turned off, another sales clerk can recognize that action against the illegal passing has been taken.

When the fixed scanner 57 scans the accounting barcode in the stand-by state (YES in ACT6), the patrol lamp 42 is lit blue (ACT11). For this reason, the sales clerk who has confirmed that the patrol lamp 42 is lit blue can know that a payment has been started in the gate device where this patrol lamp 42 is provided.

When an event that calls a sales clerk occurs during the payment (YES in ACT15), the patrol lamp 42 is lit yellow (ACT16). For this reason, the sales clerk who has confirmed that the state of the patrol lamp 42 has changed from the blue-lighted state to the yellow-lighted state can know that an event that calls a sales clerk has occurred in the gate device where this patrol lamp 42 is provided. For example, the sales clerk takes action such as checking the customer's age. When the action is completed (ACT18), the patrol lamp 42 is lit blue again (ACT19). For this reason, when the state of the patrol lamp that has been lit yellow returns to the blue lighted state, another sales clerk can recognize that the calling state has been eliminated.

In the case where the payment for the transaction identified by the accounting barcode scanned by the fixed scanner 57 has been completed using the second accounting machine 21-2 (YES in ACT20), the patrol lamp 42 blinks blue (ACT22). For this reason, the sales clerk who has confirmed that the state of the patrol lamp 42 has changed from the blue lighted state to the blinking blue state can recognize that a customer can pass through the passage PA in the gate device where this patrol lamp 42 is provided. After that, when the customer passes through the passage PA within a predetermined time (YES in ACT28), the patrol lamp 42 is turned off (ACT29). For this reason, the sales clerk who has confirmed that the patrol lamp 42 that has blinked blue is turned off can recognize that the customer who has completed the payment has passed through the gate device.

Meanwhile, in the case where the customer has not passed through the passage PA within a predetermined time (NO in ACT28), the patrol lamp 42 is lit red (ACT31). For this reason, the sales clerk who has confirmed that the state of the patrol lamp 42 has changed from the blinking blue state to the red-lighted state can recognize that a passage error has occurred in the gate device. The sales clerk takes action against the passage error. When the action is completed (ACT33), the patrol lamp 42 is turned off (ACT34). For this reason, when the patrol lamp that has been lit red is turned off, another sales clerk can recognize that the passage error state has been eliminated.

Meanwhile, in the case where the payment for the transaction identified by the accounting barcode scanned by the fixed scanner 57 has not been completed using the second accounting machine 21-2 (NO in ACT20), the first accounting machine 21-1 executes payment processing (ACT42). When an error occurs during this payment processing (YES in ACT44), the patrol lamp 42 is lit yellow (ACT45). For this reason, the sales clerk who has confirmed that the state of the patrol lamp 42 has changed from the blue lighted state to the yellow lighted state can recognize that an error has occurred during the payment in the gate device. The sales clerk takes action to resolve the error. When the action is completed (ACT47), the patrol lamp 42 is lit blue again (ACT48). For this reason, when the state of the patrol lamp that has been lit yellow returns to the blue-lighted state, another sales clerk can recognize that the error state during the payment in the gate device has been eliminated. Note that examples of the error during the payment in the gate device include a coin jam in the change machine, a receipt paper jam in the printer, and the occurrence of an offline state between the first accounting machine 21-1 and other devices due to poor communication.

When the payment processing is completed in the first accounting machine 21-1 (YES in ACT43), the patrol lamp 42 blinks blue (ACT50). For this reason, the sales clerk who has confirmed that the state of the patrol lamp 42 has changed from the blue-lighted state to the blue blinking state can recognize that the customer can pass through the passage PA in the gate device where this patrol lamp 42 is provided. After that, when the customer passes through the passage PA within a predetermined time (YES in ACT56), the patrol lamp 42 is turned off (ACT57). For this reason, the sales clerk who has confirmed that the patrol lamp 42 that has blinked blue is turned off can recognize that the customer who has completed the payment has passed through the gate device.

Meanwhile, in the case where the customer has not passed through the passage PA within a predetermined time (NO in ACT56), the patrol lamp 42 is lit red (ACT59). For this reason, the sales clerk who has confirmed that the state of the patrol lamp 42 has changed from the blinking blue state to the red-lighted state can recognize that a passage error has occurred in the gate device. The sales clerk takes action against the passage error. When the action is completed (ACT61), the patrol lamp 42 is turned off (ACT62). For this reason, when the patrol lamp that has been lit red is turned off, another sales clerk can recognize that the passage error state has been eliminated.

As described above in detail, the sales clerk can recognize the state of the gate device on the basis of the light emission color of the patrol lamp 42 and the light emission state of lighted or blinking. Specifically, when the patrol lamp 42 blinks red, the sales clerk can recognize that illegal passing has been detected. When the patrol lamp 42 is lit blue, the sales clerk can recognize that an instruction to start a transaction has been made. After that, when the patrol lamp 42 blinks blue, the sales clerk can recognize that the customer who has completed the payment can pass through the gate device. Meanwhile, in the case where the state of the patrol lamp 42 has changed from the blue-lighted state to the yellow-lighted state, the sales clerk can recognize that an event that calls a sales clerk, such as age verification, has occurred or an error has occurred in the first accounting machine 21-1. Further, in the case where the state of the patrol lamp 42 has changed from the blinking blue state to the red-lighted state, the sales clerk can recognize that the customer who has completed the payment has not passed through the gate device.

As shown in FIG. 4, the patrol lamp 42 is provided at the tip portion of the pole erected vertically to the road surface of the passage PA. For this reason, if there are no obstacles taller than the pole around the gate device, the sales clerk can check the light emission state of the patrol lamp 42 even from a relatively distant location. For this reason, according to this embodiment, it is possible to provide a gate device that allows a sales clerk to monitor the state of a device without placing the sales clerk near the device.

Further, in this embodiment, a notification signal is transmitted to the attendant terminal 23 in the notification processing in which the light emission state of the patrol lamp 42 is the blinking red state, a sales clerk call signal is transmitted to the attendant terminal 23 in the sales clerk call processing in which the light emission state of the patrol lamp 42 is the yellow-lighted state, and a passage error signal is transmitted to the attendant terminal 23 in the passage error processing in which the light emission state of the patrol lamp 42 is the red-lighted state. The attendant terminal 23 that has received the notification signal notifies that a warning for illegal passing has been issued in the gate device. The attendant terminal 23 that has received the sales clerk call signal notifies that an attendant is being called. The attendant terminal 23 that has received the passage error signal notifies that a passage error has occurred in the gate device. For this reason, the sales clerk who monitors the attendant terminal 23 does not need to keep an eye on the patrol lamp 42 of the gate device until notification is made. Therefore, he/she can carry out his/her work as an attendant more efficiently. This effect is even greater when a terminal carried by the sales clerk is adopted as the attendant terminal 23.

### Other Embodiments

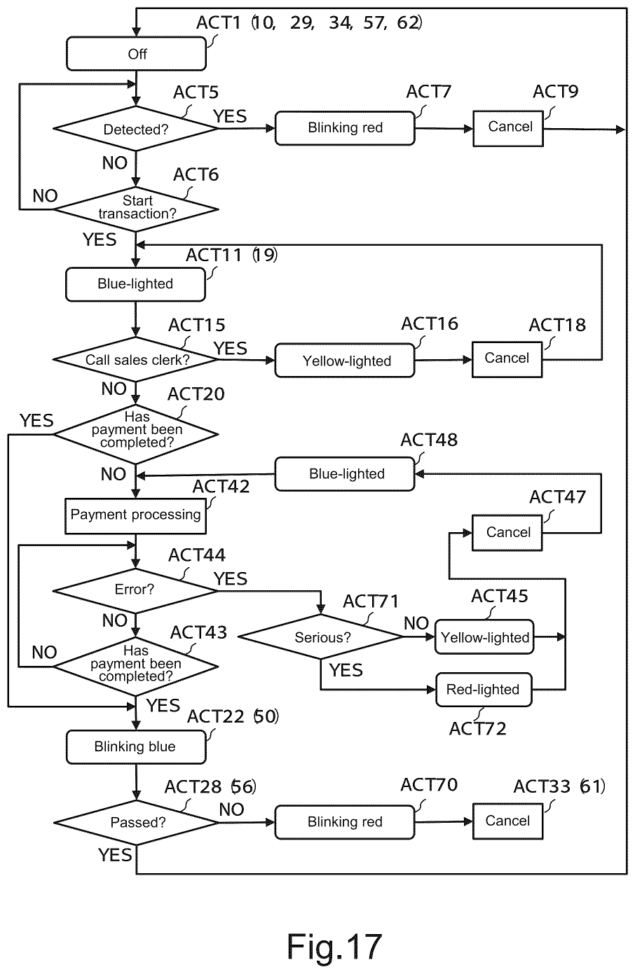

FIG. 17 is a diagram describing the state transition of the patrol lamp 42 according to a different embodiment. In the above embodiment described with reference to FIG. 16, in the case where a customer has not passed through the passage PA within a predetermined time (NO in ACT28 or ACT56), the patrol lamp 42 is lit red (ACT31). In the different embodiment, the patrol lamp 42 blinks red (ACT70) as in the case of illegal passing.

Instead, in the different embodiment, errors that occur during payment processing are classified into serious errors and minor errors. The serious error is an error that cannot be immediately resolved by a sales clerk, such as a communication error. The minor error is an error that can be easily resolved by a sales clerk, such as near-end of receipt paper and shortage of change coins.

When an error occurs during payment processing (YES in ACT44), whether the error is a serious error or a minor error is determined (ACT71). In the case of the minor error (NO in ACT71), the patrol lamp 42 is lit yellow (ACT45). Meanwhile, in the case of the serious error (YES in ACT71), the patrol lamp 42 is lit red (ACT72).

According to the different embodiment with such a configuration, in the case where the state of the patrol lamp 42 has changed from the blue-lighted state to the yellow-lighted state, it indicates that a minor error that can be easily resolved by a sales clerk in the gate device has occurred, and in the case where the state of the patrol lamp 42 has changed to the red-lighted state, it indicates that a serious error that cannot be easily resolved by a sales clerk has occurred. Therefore, the sales clerk can take action against the error on the basis of the light emission state of the patrol lamp 42 as appropriate even if he/she is not near the gate mechanism 40.

Note that the light emission state of the patrol lamp 42 is not limited to the state described in the above embodiment or different embodiment. Since some patrol lamps 42 are capable of emitting green or purple light, the light emission color may be changed as appropriate such that a sales clerk can check the state of the gate device even from a remote position.

Further, in the above embodiment, the patrol lamp 42 that is a light emitter is provided at the tip portion of the pole erected vertically to the road surface of the passage. In another embodiment, a light emitter having two or more types of light emission states may be held in a holder suspended from a ceiling or the like above the gate mechanism 40 and the light emission state of the light emitter may be changed to different states between the first mode and the second mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A gate device, comprising:
a gate mechanism that is disposed along a passage through which a customer passes and includes
a light emitter that is provided above the gate mechanism, and
a detector configured to detect a person passing through the passage; and
a processor configured to
switch an operation mode of the gate mechanism between a first mode in which notification is made by the light emitter when the detector detects a person passing through the passage and a second mode in which no notification is made even when the detector detects a person passing through the passage, and
change a light emission state of the light emitter to different states between the first mode and the second mode.

2. The gate device according to claim 1, further comprising
an accounting machine that is provided upstream of the passage and makes a payment for a transaction with the customer,
the accounting machine receiving an instruction to start the transaction by receiving an operation of the customer for the payment,
the processor being further configured to start, upon receiving the instruction to start the transaction, payment processing for making a payment for the transaction.

3. The gate device according to claim 2, wherein
the processor is further configured to
set, before receiving the instruction to start the transaction, the operation mode of the gate mechanism to the first mode to make the light emission state of the light emitter a first light emission state, and
change, where the instruction to start the transaction has been received in the first mode, the light emission state of the light emitter from the first light emission state to a second light emission state.

4. The gate device according to claim 3, wherein
the processor is further configured to
determine whether or not the detector has detected a person in the first mode,
determine, where the detector has detected a person, whether or not the instruction to start the transaction has been received, and
change, where the instruction to start the transaction has been received, the light emission state of the light emitter from the first light emission state to the second light emission state.

5. The gate device according to claim 2, wherein
the processor is further configured to change the light emission state of the light emitter to a third light emission state while performing the payment processing.

6. The gate device according to claim 5, wherein
the payment processing includes processing of determining whether or not content of the transaction includes a transaction that requires calling a sales clerk, and
the processor is further configured to
change, where the instruction to start the transaction has been received in the first mode, the light emission state of the light emitter from the first light emission state to the second light emission state, and
set, where content of the transaction includes no transaction that requires calling a sales clerk, the operation mode of the gate mechanism to the second mode to change the light emission state of the light emitter from the second light emission state to the third light emission state.

7. The gate device according to claim 6, wherein
the processor is further configured to determine, where content of the transaction includes a transaction that requires calling a sales clerk, an event that calls a sales clerk has occurred, and change the light emission state of the light emitter from the second light emission state to a fourth light emission state different from the third light emission state.

8. The gate device according to claim 7, wherein
the event that calls a sales clerk includes an error that has occurred in the payment processing, and
the processor is further configured to change the light emission state of the light emitter in accordance with a level of the error.

9. The gate device according to claim 4, wherein
the processor is further configured to change, where the detector has detected a person, the light emission state of the light emitter from the second light emission state to a fourth light emission state different from the second light emission state.

10. The gate device according to claim 1, wherein
the light emitter is a patrol lamp provided at a tip portion of a pole erected vertically to a road surface of the passage.
